(19) United States
(12) Patent Application Publication
(10) Pub. No.: US 2026/0189827 A1
(43) Pub. Date: Jul. 2, 2026

(54) Portable Wireless Outdoor Loudspeaker

(71) Applicant: Turtlebox Audio, LLC, Houston, TX (US)

(72) Inventors: Evan Maverick James QUIROS, Houston, TX (US); Reagan Crockett FINCHER, Houston, TX (US); Jonathan Michael MCKENZIE, Houston, TX (US); William Douglas BRADLEY, Houston, TX (US); Jeffrey Dan BEZNER, Katy, TX (US); Joel Ryan HIERHOLZER, Altamonte Springs, FL (US); Zachary Marshall ETTER, Battle Ground, WA (US); Brian Kelly RADGOWSKI, Tryon, NC (US); Vic Omer RICHARDSON, Kirkland, WA (US)

(21) Appl. No.: 19/327,943

(22) Filed: Sep. 12, 2025

Related U.S. Application Data
(60) Provisional application No. 63/740,060, filed on Dec. 30, 2024.

(51) Int. Cl. H04R 1/02; G06F 3/16; H04R 3/00

(52) U.S. Cl. CPC H04R 1/025; G06F 3/162; G06F 3/165; H04R 1/023; H04R 1/026; H04R 3/00; H04R 2420/07; H04R 2420/09

(57) ABSTRACT

The disclosed principles provide a portable wireless speaker designed and constructed for outdoor use. In one embodiment, a speaker in accordance with the disclosed principles comprises an inner structure defining a watertight hollow cavity within the inner structure. A large, circular speaker driver, having a diameter substantially coextensive with one or more of the length or width of the speaker housing is employed. The speaker comprises a watertight housing constructed of a thin, lightweight, water proof material, such as plastic. Structural ribs are integrally formed with the interior surface of the front panel of the housing and with perpendicular structures extending from the interior surface and sidewalls of the front panel, and additional structural ribs are integrally formed with the interior surface of the back panel of the housing and with perpendicular structures extending from the interior surface and sidewalls of the front panel. These structural ribs substantially reduce or eliminate flexing of the thin front and back panels, thereby permitting operating circuitry turning to optimize sound quality emanating from the speaker.

### RELATED APPLICATIONS

The present disclosure claims priority to U.S. Provisional Patent Application Ser. No. 63/740,060, filed Dec. 30, 2024, the entirety of which is incorporated herein by reference for all purposes.

### TECHNICAL FIELD

The present disclosure is generally related to the field of portable wireless speakers, and more particularly to novel portable wireless waterproof outdoor speaker and methods of manufacture thereof.

### BACKGROUND

With the advent of portable devices, such as smart phones, capable of storing large amounts of music, the desire for portable speakers that can produce quality sound reproduction has continued to increase. This has led to the proliferation of wireless speakers, especially those powered by long-life batteries, such as lithium-ion batteries, and capable of wireless connection to music sources, such as through Bluetooth technology. Along with desired portability of such wireless speakers, a continued desired for maintaining sounds quality in portable-sized speaker exists. Specifically, sound quality is typically proportional to speaker size, and thus as a result, as portable wireless speakers continue to shrink in size in order to increase their portability, sound quality typically suffers.

To combat the typical decrease in sound quality for portable speakers, a rising market in larger wireless portable speakers has developed. Understanding consumers'desire for high quality sound in their portable speakers, as well as for portable uses that include high volume uses like sharing the played sound for groups of people, manufacturers have begun designing larger portable speakers for those uses that are not limited to small personal portable speakers. Unfortunately, such larger speakers must still be portable for this niche market, and thus the use of strong, thick materials (e.g., wood) for the speaker casing is not an option lest the speaker become too heavy to be portable. However, the use of lighter weight material for the speaker housing/casing, such as lightweight plastic, traditionally affects sound quality negatively. This loss of sound quality is exacerbated when the speaker casing is increased relative to the size of the speaker driver(s) so that the larger hollow cavity improves sounds quality. This is because the lightweight plastic or similar material flexes more easily, causing acoustic wave reverberations can result in distortion in the sound produced by the speaker. This is especially true of the areas of the casing located immediately behind the speaker driver(s).

Furthermore, along with the portability of speakers comes a desire to employ portable speakers in outdoor environments. Thus, the use of speakers in outdoor environments creates new concerns of damage caused by water/moisture, as well as dust and other contaminants present in typical outdoor environments. Even full water resistance of portable speakers is becoming more desirable to accommodate use in boats, pools, and other predominantly water-based environments where direct exposure to water is a constant possibility. However, just as the lightweight casings of larger portable speakers directly impacts sound quality, so too does the reinforcement of portable speaker construction against the elements, especially moisture/water. The more protected the portable speakers become against water and other potential damages elements, typically the worse the sound quality becomes.

Accordingly, what is needed in the art is a portable wireless speaker and related methods of manufacture that are small enough to be portable but large enough to produce similar sound quality to large indoor speakers, yet be fortified against the elements and not suffer from the deficiencies in sound quality found with conventional large portable speaker designs. The disclosed principles provide such unique large portable wireless speakers and related methods of manufacture thereof.

### SUMMARY

To overcome the deficiencies of the prior art, the disclosed principles provide a portable wireless speaker designed and constructed for outdoor use. In one embodiment, a speaker in accordance with the disclosed principles comprises an inner structure defining a watertight hollow cavity within the inner structure. In addition, such a speaker as disclosed herein comprises a speaker driver mounted within the hollow cavity. In accordance with the disclosed principles, the size of the speaker driver employed with a speaker as disclosed herein is selected such that, in the case of a speaker driver having an elliptical shape, the length of its major axis is substantially coextensive with the width of the speaker case and the length of its minor axis is substantially coextensive with the height of the speaker case. In the case of a circular speaker driver, the diameter of the drive is selected to be substantially coextensive with both the width and height of the speaker case if the case is substantially square, or selected to be substantially coextensive with both the smaller of the width or height of the speaker case if the case is rectangular. In the case of any other shape of speaker driver, the same disclosed principles apply, where the outer length, width, or diameter of the speaker driver is selected to be coextensive with the corresponding width and/or height of the speaker case. Such selection of speaker driver size of a speaker as disclosed herein results in as large a driver as possible to be used with respect to the size and shape of the speaker casing. This ratio of driver size to casing size permits the loudest acoustic output per casing size.

Exemplary speakers as disclosed herein may further comprise a plurality of control buttons mounted at least partially within the hollow cavity for controlling corresponding operations of the speaker, and a rechargeable battery providing power to components of the speaker. Moreover, such exemplary speakers may comprise one or more circuit boards mounted within the hollow cavity and powered by the battery, the one or more circuit boards configured to drive the speaker driver and to receive control inputs via the plurality of control buttons.

Exemplary speaker embodiments in accordance with the disclosed principles additionally include structural ribbing formed on the interior surface of the backwall of the lightweight speaker casing in order to reduce or prevent sound distortion, especially at high volume levels that are typically desired when the speaker is used in an outdoor setting. Specifically, as discussed above, the use of lightweight thin materials, such as plastic, permits the creation of a durable and waterproof speaker casing, yet lightweight enough to enhance portability of the speaker. Employing lightweight and thin materials is especially beneficial when large speaker drivers are employed, which tend to be relatively heavy. Selecting a speaker driver size as large as possible for a given speaker case size results in the maximum sounds per case size, but then can also result in more sound distortion from internal acoustic wave interference caused by wave deflections off of conventionally thin backwalls of the speaker case in multiple directions when such thin backwalls flex in response to sound generation. Consequently, conventional portable speakers with large (i.e., heavy) speaker drivers housed in lightweight and thin speaker casing (i.e., to offset the driver weight) suffer from loss of sounds quality that increases as the volume of the speaker is increased. A weatherproof, portable speaker designed and constructed in accordance with the disclosed principles overcomes these issues.

### BRIEF DESCRIPTION OF THE DRAWINGS

The novel features believed to be characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawing, in which:

FIG. 1 illustrates a front view of one embodiment of an outdoor portable wireless speaker designed and constructed in accordance with the disclosed principles;

FIG. 2 illustrates a top view of the speaker illustrated in FIG. 1;

FIG. 3 illustrates a backside view of the speaker illustrated in FIGS. 1 and 2;

FIG. 4 illustrates a right side view of the speaker illustrated in FIGS. 1-3;

FIG. 5 illustrates a left side view of the speaker illustrated in FIGS. 1-4;

FIG. 6 illustrates a bottom view of the speaker illustrated in FIGS. 1-5;

FIG. 7 illustrates a front isometric view of the speaker illustrated in FIGS. 1-6;

FIG. 8 illustrates an interior view of the back panel of the speaker illustrated in FIGS. 1-7;

FIG. 8A illustrates an interior view of an alternative embodiment of the interior of the back panel, also designed and constructed in accordance with the disclosed principles;

FIG. 9 illustrates a front view of the speaker illustrated in FIGS. 1-8 with the speaker grille removed;

FIG. 10 illustrates an interior view of the speaker grille of the speaker illustrated in FIGS. 1-9;

FIG. 11 illustrates an interior view of the front panel of the speaker illustrated in FIGS. 1-10.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Although multiple embodiments are shown and discussed in great detail, it will be apparent to those skilled in the relevant art that some features that are not relevant to the present invention may not be shown for the sake of clarity.

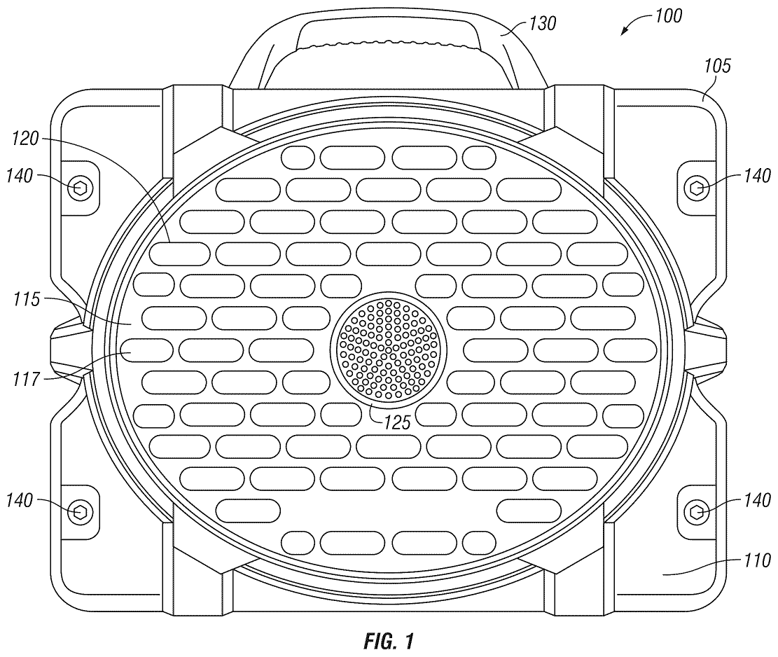

Referring initially to FIG. 1, illustrated is a front plan view of one embodiment of an outdoor portable wireless speaker 100 designed and constructed in accordance with the disclosed principles. The speaker 100 includes, in this embodiment, a sealed housing comprising two sides, a top, and bottom; however, any number of additional sides may also be provided while maintaining the advantages disclosed herein. Additionally, the illustrated speaker 100 has a longitudinal rectangular shape, but in other embodiments it may have a square shape or a vertical rectangular shape. A top panel 105 can be seen as well as a front panel 110, wherein the front panel 110 is shown secured to a back panel (discussed below) with removable fasteners 140. These fasteners may be provided as screws, rivets, clips, or any other advantageous type of fastener capable of securing the front panel 110 to the back panel.

Affixed to the front panel 110 is a speaker grate or grille 115, which in some embodiments may be affixed to the interior surface of the front panel 110, and in other embodiments may be affixed to the exterior of the front panel 110 as in the illustrated embodiment. Apertures 120 may be formed across the surface of the front panel 110, to permit acoustics generated by the speaker driver 117, which in this embodiment is a woofer 117 and is discussed in more detail below, to be emitted outside of the speaker 100. The speaker grille 115 may be constructed of a durable material, such as plastic or metal, but any material that offers protection to the underlying woofer 117 may be employed. In this illustrated embodiment, the grille apertures 120 are rectilinear ellipses (i.e., “slot-shaped”) of various lengths, but in other embodiments the apertures 120 may take other shapes, such as circular, elliptical, square, rectangular, trapezoidal, or other polygonal shape, or any combination thereof. Advantageously, the area occupied by the apertures 120 is substantially more than the surface area of the grille 115 without an apertures 120 such that the grille 115 permits a primarily unobstructed emanation of acoustic waves from the underlying woofer 117. In exemplary embodiments, the area occupied by the apertures 120 is at least twice the area of the grille 115 without apertures 120; however, even other ratios may also be employed. In some embodiments, the ratio of aperture area to non-aperture area is selected based on the thickness of the grille 115 and the type of material used for the grille 115.

Located at the center of the grille 115 is a tweeter (not illustrated) covered and protected by a tweeter cover 125. The tweeter cover 125 may, in some embodiments, be constructed of the same material as the grille 115. In some embodiments, the tweeter cover 125 may be formed integrally with the grille 115, while in other embodiments the tweeter cover 125 is affixed to the grille 115. The alignment of the tweeter and the tweeter cover 125 in advantageous embodiments of a speaker 100 as disclosed herein provides a coaxial alignment of the tweeter with the woofer 117, and in more specific embodiments, the diameter of the tweeter and tweeter cover 125 are selected to be substantially equal to the dust cap or “dome” (not illustrated) covering the voice coil of the woofer 117. Such coaxial alignment results in the tweeter and tweeter cover 125 not obstructing the acoustic waves emanating from the woofer 117, resulting in a more equal sound distribution from the speaker 100.

Affixed to and extending from the top panel 105 is a handle 130 for grasping the speaker 100. In advantageous embodiments, top panel 105 and the handle 130 may all be formed at least partially from an impact resistant material so as to resist damage to the speaker 100 and/or handle 130 should it be dropped. In many embodiments, the material of the handle 130 may include a soft, tacky material on its exterior, such as rubber or a similar material, which promotes a non-slip surface to grasp the speaker 100. In some specific embodiments, the handle 130 may be separate from the impact resistant material comprising the top panel 105, and thus be affixed to the speaker 100 through the top panel 105, which is described in more detail below. Also, in exemplary embodiments, the height of the handle 130 may be about 1 inch, with the width of the handle 130 about 1¼ inch. In more specific embodiments, the handle 130 has a height of 0.85 inch with a width of 1.30 inches. Such dimensions provides a comfortable handle size for an average adult to grasp, even for long periods of carrying. Additionally, the cross-sectional profile of the handle 130 may be elliptical or discorectangular, adding to the grasping comfort of the handle 130.

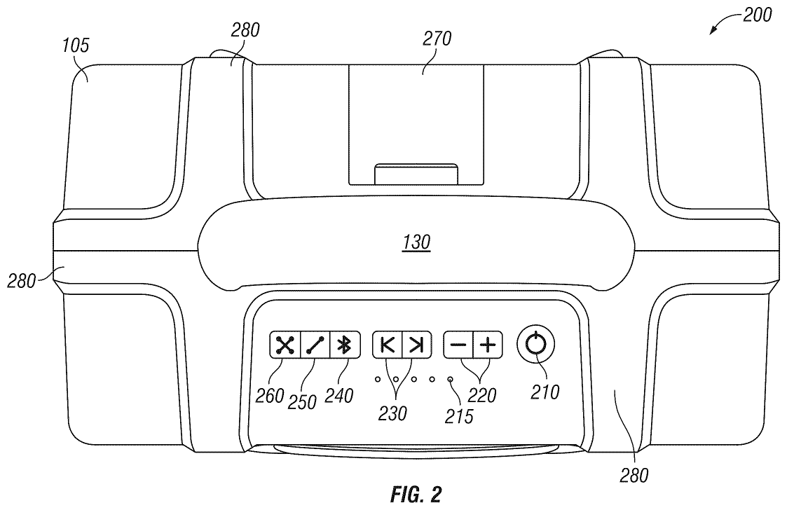

Turning now to FIG. 2, illustrated is a top view 200 of the speaker 100 illustrated in FIG. 1. From this top view of the speaker 100 the top panel 105 and handle 130 may be seen. In addition, located on the top panel 105 is a plurality of buttons. Also visible on the top panel 105 are illuminating lights 215 (e.g., LEDs) that may indicate the current battery life of the speaker 100, both during use (i.e., remaining battery life) and during charging (i.e., how much charge has been stored by the internal batteries).

In this embodiment, the buttons comprise a power button 210, which may also function as a start/play and pause button for any media being played on the speaker 100, as well as volume buttons 220, previous and next track buttons 230, and connectivity buttons 240, 250, 260. More specifically, a Bluetooth connectivity button 240 is used initiating a Bluetooth connection between the speaker 100 and a user's media player, such as their mobile phone. Also, a stereo connection button 240 is provided to initiate a wireless connection between the speaker 110 and a second speaker (not illustrated) to provide a more immersive stereo sound. Finally, a “party mode” button 260 is may also be provided to initiate wireless connectivity between the speaker 100 and a two or more other speakers (not illustrated) configured for such interconnectivity in order to simultaneously produce sounds from all of the speakers. Advantageously, the buttons and battery indicator lights 215 may include a rubber or other waterproof cover on each of them in order to protect the interior components from water and other elements the speaker 100 may encounter.

Also illustrated on the top panel 105 is a charging port cover 270. This charging port cover 270 houses the charging port for the speaker 100, which may be any type of advantageous charging port, such as USB-A, USB-C, USB mini, USB micro, or any other type of low voltage electrical charging point either now existing or later developed. The charging port cover 270 may advantageously be constructed of a waterproof material, such as rubber, such that a seal between the charging port cover 270 and the top panel 105 prevents water and other contaminants from entering the interior of the speaker 100. In some embodiments, charging port cover 270 may instead be constructed of a rigid material, such as a plastic material, and a seal (not visible) provided between the cover 270 and a recessed area of the top panel 105 such that the charging (and any other) port is hermetically sealed from the environment. In such embodiments, the cover 270 may be hinged with respect to the top panel 105 such that a user opens the cover 270 by lifting one end of the cover 270 such that it pivots on such a hinge. In such embodiments, a clipping or other fastening mechanism may be provided to securely close the cover 270 against the top panel 105. Of course, any other type of removable design and structure for the charging port cover 165 may also be included.

Top support bands 280 may also be seen from the top view of FIG. 2. These support bands 280 are provided across the top panel 105, in perpendicular directions, to provide additional structural support to the housing of the speaker 100. Additionally, such support bands 280 may provide an aesthetic purpose to the speaker 100, lending a rugged ornamental appearance to the speaker 100. The support bands 280 may be formed as thicker portions of the top panel 105 (and other panels of the speaker 100 the support bands 280 extend to) and thus be integrally formed with those areas of the top panel 105. In other embodiments, the support bands 280 may be adhered or otherwise attached to the illustrated areas of the top (and other) panel 105. Also, the support bands 280 may be formed of the same material as the top panel 105 or they may be formed from a different material, such as softer material to provide bumper-type protection to those areas of the speaker 100 having the support bands 280. In exemplary embodiments, the support bands 280 may be formed with a width of about 1 inch, but other dimensions may also be employed. The support bands 280 may also be formed with a tapered shape when moving from the top (or bottom) of the speaker housing to the front and back panels. For example, in advantageous embodiments, the support bands 280 have a taper where the widest portion is 1.50 inches, while the narrowest portion is 1.30 inches. Such tapered shape can provide a more aesthetic appearance, while still providing the structural support on the exterior surfaces of the housing. Edges of the support bands 280 may be rounded or chamfered to present a smooth surface to the user's touch as well.

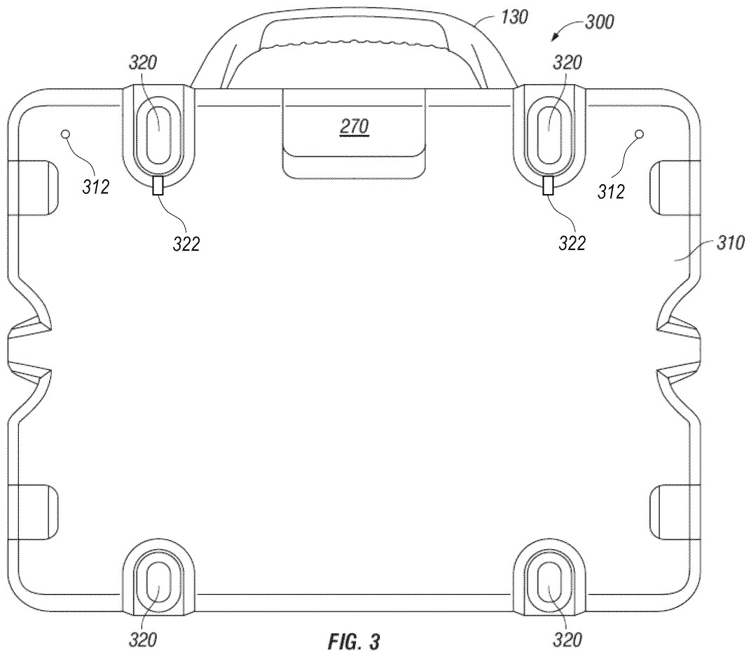

Turning now to FIG. 3, illustrated is a back view 300 of the speaker 100 illustrated in FIGS. 1-2. From this back view, the front side of the cover 270 can be seen, as well as a part of the recess corresponding to the cover 270 and providing space for a user to reach in and lift the cover 270 open.

Formed on the back panel 310 of the speaker 100 housing are feet 320. These feet 320 may be used to lay the speaker 100 on its back on a rigid surface so that the sound emanate upwardly and out. In advantageous embodiments, the feet 320 may be formed of a tacky material to resist the speaker 100 sliding along the surface on which it has been laid. In some embodiments, the feet 320 may be constructed of a rubber material, which advantageously also resists vibrations from the speaker 100 to the surface. In some embodiments, the feet 320 are removable for easy replacement when worn out, and/or for concealing fasteners (e.g., screws) used to affix the back panel 310 and the front panel 110.

In other embodiments, the feet 320 may comprise magnets having enough magnetic attraction to not only hold the speaker against the metal surface on which it is mounted, but also strong enough to resist bumps and other movements and vibrations that might otherwise knock the speaker 100 loose from its magnetic attachment to the surface. In some embodiments, such magnetic speaker mounts collectively have a magnetic field multiple orders of magnitude greater than an overall weight of the speaker 100, such that the speaker 100 may be mounted to a vertical surface (e.g., a wall) or even facing downward such that it is suspended from a horizontal mounting surface.

Also illustrated in FIG. 3 are optional “breather” holes 312 formed through the back panel 310. Such breather holes 312 may be used to connect the sealed interior of the housing to the outside environment. The inclusion of such breather holes 312 permits the release of pressure build up from within the sealed housing that may occur when acoustic waves are generated and reverberate within the housing, especially as the amplitude (i.e., volume) of acoustic waves is increased. In advantageous embodiments, the breather holes 312 permit bidirectional airflow, but include a membrane, mesh, or other material that permits airflow through it but prevents water from flowing through it and into the sealed housing. Although the breather holes 312 in the embodiment of FIG. 3 are positioned along the top corners of the back panel 310, in other embodiments the breather hole or holes 312 may be positioned elsewhere on the back panel 310, or alternatively or additionally formed through other panels of the housing. Also, a greater or lesser number of breather holes 312 may also be employed, if there are included in a speaker as disclosed herein.

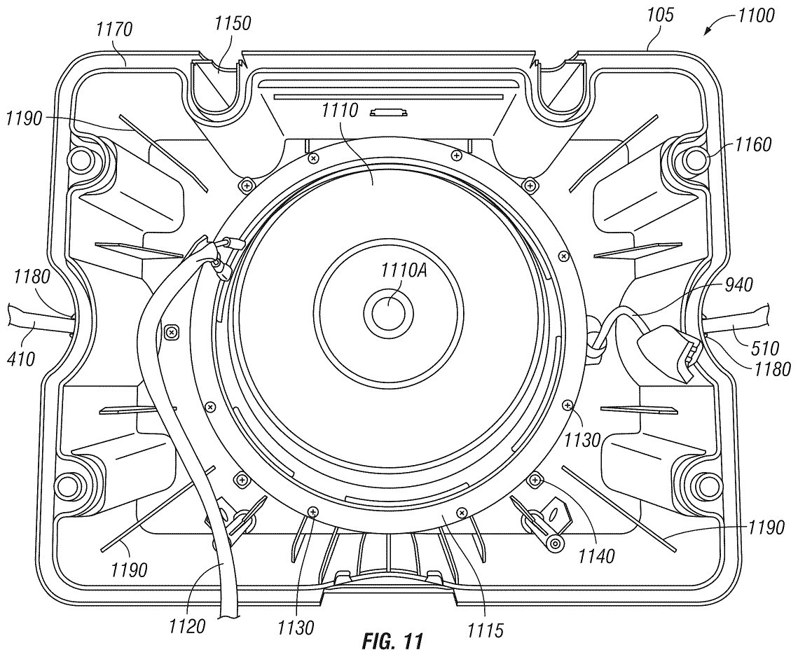

Also illustrated in FIG. 3 are drain channels 322 formed through the back panel where the upper feet 320 are located. Specifically, under these upper feet 320 may be passages where fasteners, such as screws, are used to secure opposing ends of the handle 130. This means for affixing the handle 130 to (and within, in the case of the opposing ends of the handle 130) the housing provides a very strong connection between the handle 130 and the housing as compared to simply affixing the handle 130 to the top panel 105 of the housing. However, in using such fasteners to secure the ends of the handle 130 to the housing, to maintain the watertight seal of the housing, the seal or gasket may be configured to pass under the passages having these fasteners (shown at the top of the housing in FIG. 11). This can result in the accumulation of water in these fastener passages, and the drain channels 322 are therefore used to drain any water that has accumulated in these passages.

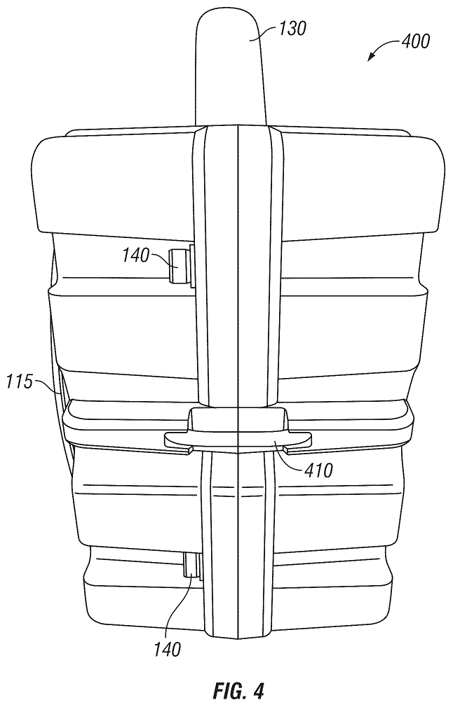

Looking now at FIG. 4, illustrated is a right side view 400 of the speaker 100 illustrated in FIGS. 1-3. From this view, the handle 130 and grille 115 are still visible, as are two of the fasteners 140 used to affix the front panel 110 to the back panel 310. Channels may be formed into the sides of the speaker housing where the fasteners 140 are positioned such that they do not extend outside the perimeter of the speaker's exterior sidewalls. Also, these channels, which as illustrated are formed inwardly from the side panels or sidewalls of the housing, provide additional structural support for the speaker's housing by providing alternating inward and outward walls along the side panels. These channels may be formed with a tapered shape to assist with an injection molding process and access to the fasteners 140, however, straight channels may also be formed.

A right side tie down bar 410 may also be affixed to the casing or housing of the speaker 100 for use in receiving a strap or similar device in order to tie down the speaker 100 to a surface so that it does not move during use or perhaps to prevent theft. In exemplary embodiments, the tie down bar 410 may be metal for additional strength, but other materials may also be used for the tie down bar 410. In some embodiments, one or more additional tie down bars (not illustrated) may be provided on other areas of the speaker 100, such as on the back, front, top, or bottom of the speaker 100, or even added to the right side of the speaker 100. Channels like those formed for accessing the fasteners 140 may also be formed above and below the area of the housing sidewalls where the tie down bars 410 are held. Including such additional channels provides further structural support of the housing sidewalls.

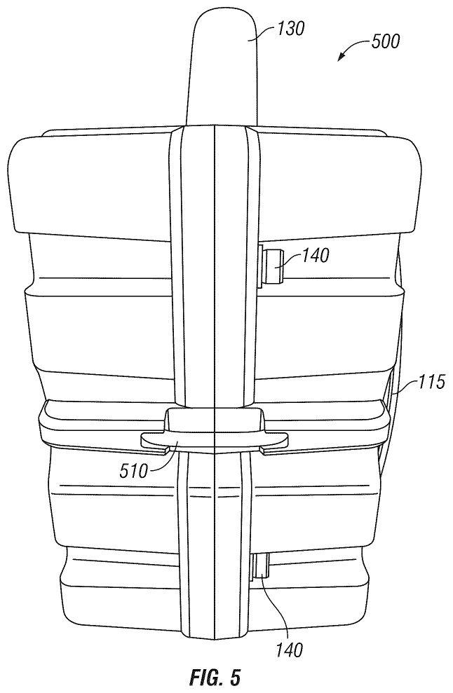

Turning briefly to FIG. 5, illustrated is a left side view 500 of the speaker 100 illustrated in FIGS. 1-4. As before, from this view, the handle 130 and grille 115 are still visible, as are the other two fasteners 140 used to affix the front panel 110 to the back panel 310. A second (left) tie down bar 510 is also visible, which may be the same or similar to the right tie down bar 410 illustrate in FIG. 4. Also as before, one or more additional tie down bars (not illustrated) may be provided on other areas of the speaker 100 or added to the left side of the speaker 100 along with tie down bar 510.

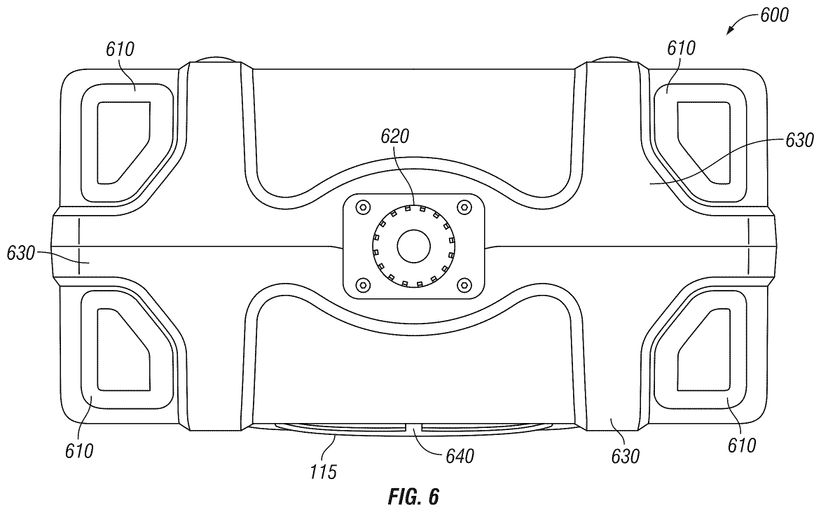

FIG. 6 illustrates a bottom view 600 of the speaker 100 illustrated in FIGS. 1-5. Formed on the bottom panel of the speaker 100 housing are bottom feet 610. These feet 610 are used to set the speaker 100 on a surface in an upright position so that the sound emanates horizontally in the direction the speaker 100 is facing. As before, in exemplary embodiments, the feet 610 may be formed of a tacky material to resist the speaker 100 sliding along the surface on which it has been set down. In some embodiments, the feet 610 may be constructed of a rubber material, which advantageously also resists vibrations from the speaker 100 to the surface. In some embodiments, the feet 610 are removable for easy replacement when worn out, and/or for concealing fasteners (e.g., screws) used to secure one or more components within the interior of the speaker 100.

In some embodiments, the feet 610 may again comprise magnets having enough magnetic attraction to not only hold the speaker against the metal surface on which it is mounted, but also strong enough to resist bumps and other movements and vibrations that might otherwise knock the speaker 100 loose from its magnetic attachment to the surface. In some embodiments, such magnetic speaker feet 610 collectively have a magnetic field multiple orders of magnitude greater than an overall weight of the speaker 100, such that the speaker 100 may be mounted to a vertical surface (e.g., a wall) or even upside down while being suspended from a horizontal mounting surface.

Also visible in the bottom view is a speaker mounting receptacle 620. Such a receptacle 620 may be included with the speaker 100 so that it may be mounted onto a pole, such as the pole of a tripod. Additionally, the receptacle 620 may be formed with splines as illustrated, or other similar features, that prevent the speaker 100 from spinning or otherwise rotating on the pole. In some embodiments, the receptacle 620 may include a fastening mechanism that may be used to not only secure the speaker 100 onto a pole or similar mount, but also that permits suspending the speaker 100 in an upside down orientation. Such a securing feature of the receptacle 620 permits easy mounting of the speaker 100 to a ceiling or similar surface. In some embodiments, the receptacle 620 is compatible with photography equipment mounts and/or home theater projector mounts to permit universal mounting options to readily available mounting systems. Of course, any other type of mounting or fastening mechanism may be included in the receptacle 620 as well.

Bottom support bands 630 may also be seen in the view 600 of FIG. 6. These support bands 630 are formed similarly to the top support bands 280 discussed above, and can also be functional to provide strength to the housing of the speaker 100, ornamental/decorating to illustrate ruggedness of the speaker 100, or both. A bottom view of the grille 115 is also visible from the bottom view of FIG. 6. From this view, the convex shape of the grille 115 can be seen. Such a shape can provide increased structural support to the grille 115 as compared to a flat grille. Additionally, in advantageous embodiments, the grille 115 may be constructed of a resiliently flexible material, such as ABS plastic, that allows some flexing while resiliently returning to its original convex shape. Employing such material for the grille 115 permits the grille 115 to rebound from an impact against it to its original shape. In exemplary embodiments, the height of the convex curvature of the grille 115 may be about 1 inch, which provides an advantageous balance of structural strength of the grille 115 and preventing the grille 115 from protruding too far from the front exterior surface of the speaker housing. However, other heights (i.e., increased curvatures having a smaller radius) may also be employed for the grille 115, as desired.

Also visible from this bottom view 600 is a grille drain port 640. Since the grille 115 is advantageously rigidly affixed to the outer surface of the front panel 105 and includes numerous slots/apertures 120 for the passing through of sound waves, water or other contaminants can pass through the grille apertures 120 and collect between the interior of the grille 115 and the outer surface of the front panel 105 of the outer surface of the woofer 117. This unique port 640 is formed at the bottom-most portion of the grille 115 when the speaker 100 is sitting upright on the bottom feet 610. This orientation of the port 640 permits any collected contaminants to drain via gravity from the interior of the grille 115, through the port 640, and away from the speaker 100. Although only one port 640 is illustrated, in other embodiments multiple such drain ports may be provided. In some embodiments, one or more such ports may be provided at other locations around the perimeter of the grill 115 to permit the described draining if the speaker 100 is positioned in other orientations. For example, if the speaker 100 is suspended upside down as described above, and drain port at the top of the grille 115 would permit draining while the speaker 100 is in this upside down orientation. Similarly, other such ports formed in other locations around the perimeter of the grille 115 would permit such draining if the speaker 100 is placed or attached to non-level surfaces, such as being attached to a vertical mounting surface or wall. Of course, such port(s) can be provided in any advantageous position around the perimeter of the grille 115.

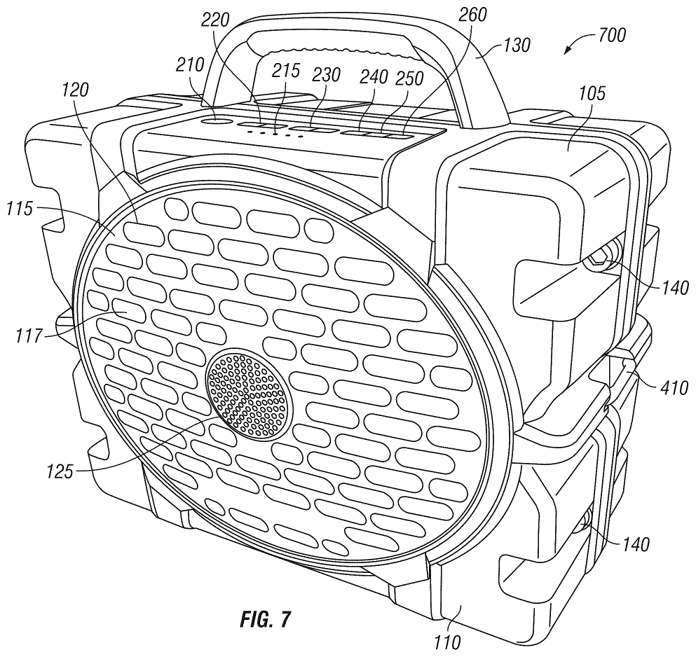

Turning now to FIG. 7, illustrated is a front isometric view 700 of the speaker 100 illustrated in FIGS. 1-6. This illustrated view provides context to the front view of FIG. 1, the top view of FIG. 2, and the right side view of FIG. 3. The front panel 110 having the grille 115 attached thereto is again shown, as is the handle 130 extending from the top panel 105 and the plurality of operable buttons 210, 220, 230, 240, 260 and battery level indicator lights 215.

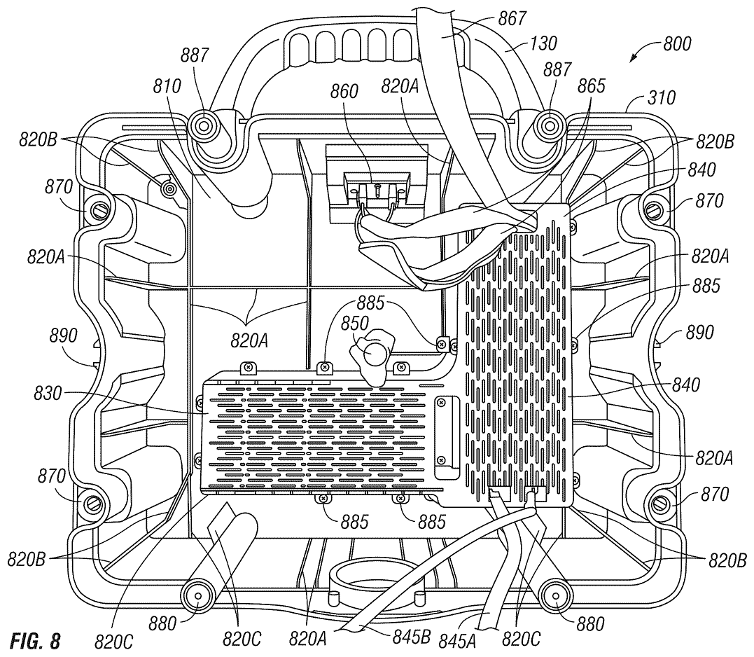

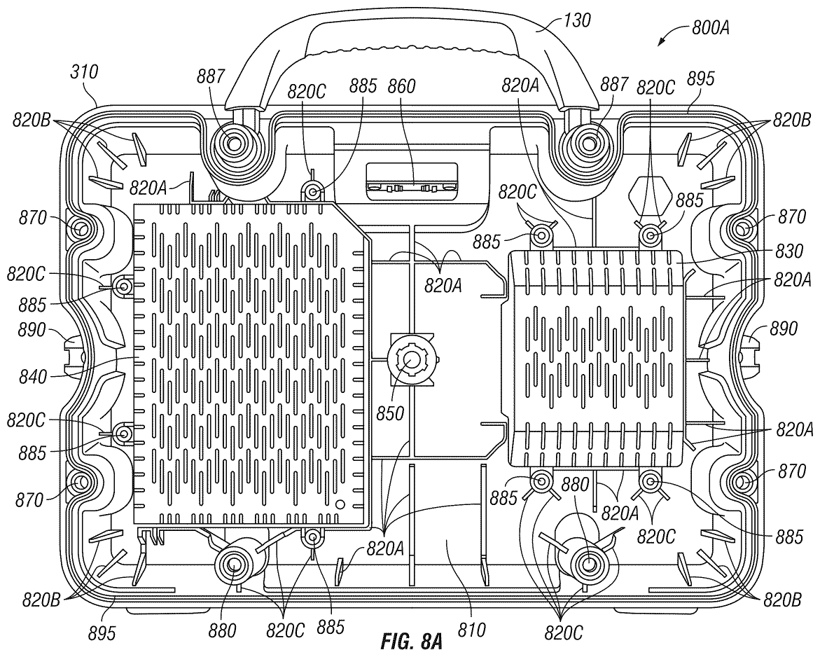

Looking now to the interior of the speaker 100, illustrated in FIG. 8 is an interior view 800 of the back panel 310. Providing the structural integrity of the back panel 310 is a plurality of structural ribs 820 formed all throughout the interior surface 810 of the back panel 310. Each of these ribs 820 extends along a portion of the interior of the back panel 310 and rise up vertically from the back panel 310, up interiors surfaces of either a sidewall/side panel, the top panel, and the bottom panel of the back portion of the housing or a ‘tower’ configured to receive a fastener. Several primary ribs 820A are formed extending perpendicularly along portions of the interior surface 810 of the back panel 310. These ribs 820A provide a substantial portion of the structural support of the back panel 310 with respect to the top and bottom panels, and the side panels, of the housing of the speaker 100. Specifically, by extending along long portions of the back panel 310 and intersecting with one another, which may be perpendicularly as illustrated, these ribs 820A remove some or all of the flexibility of the back panel 310. Not only does this provide significant structural support for the back panel 310, but limiting or eliminating any flexibility in the back panel 310 during use of the speaker 100 significantly improves sound quality of speaker 100. This acoustic effect and improvement are discussed in further detail below.

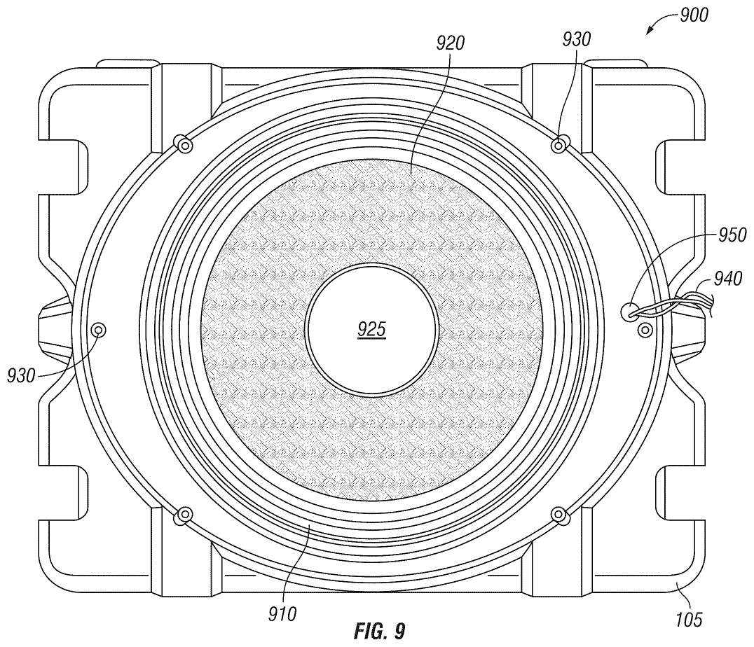

The height of the ribs 820 extending perpendicularly from the interior surface of the back panel may be selected as a result of the thickness of one or both of the back panel and ribs 820 themselves. In exemplary embodiments, if the back panel 310 has a thickness of about 0.15 inch, the ribs 820 may be formed with a thickness of about 1/16 inch. As such, the thickness of the ribs 820 is inversely proportional to the thickness of the back panel 310. Thus, as the thickness of the back panel 310 increases, its flexibility is decreased and thus thinner ribs 820 are required to further eliminate its flexibility. Conversely, as the thickness of the back panel 310 decreases, its flexibility increases and thus thicker ribs 820 are required to reduce or eliminate its flexibility. Additionally, the height of the ribs 820 can further affect their effectiveness at decreasing the flexibility of the back panel 310. For example, as the height of the ribs 820 increases, their effectiveness of decreasing the flexibility of the back panel 310 increases. Thus, the height of the ribs 820 is inversely proportional to their thicknesses, where thicker ribs 820 may be formed at a shorter height than thinner ribs 820 and yet maintain the same effectiveness at decreasing the flexibility of the back panel 310. In exemplary embodiments, for ribs 820 having a thickness of 1/16 inch and the back panel 310 has a thickness of ⅛ inch, a height of the ribs 820A of ½ inch, as illustrated in FIGS. 8 and 9, is typically sufficient to eliminate substantially all of the flexibility of back panel 310 comprising ABS plastic at the location of the ribs 820. Additionally, ribs 820B and 820C may also taper from a larger height to their final smaller height as they extend up one or more of the top panel, the bottom panel, the side panels, interior corners of the speaker housing, or any of the towers 880, 885, as illustrated in FIGS. 8 and 9.

In some cases, the ribs 820 also extend up sidewall surfaces that are perpendicular to the back panel 310 to provided additional structural support in these areas. For example, at the four exterior corners of the housing, ribs 820B structurally connect the back panel 310 to side panels of the speaker housing and either the top or bottom panels of the speaker housing depending on the location of the ribs 820B. These particular ribs 820B provide structural support to resist the housing cracking or breaking if the speaker 100 is inadvertently dropped or otherwise impacted on its corners. Other ribs 820C also extend along portions of the back panel 310 and vertically along other structures within the interior of the speaker 100. For example, ribs 820C extend upwardly along mounting towers 880 formed on the interior of the back panel 310. Such mounting towers 880 are positioned to receive fasteners, such as screws, extending from the front panel (not illustrated here) of the speaker housing and used to affix the front and back panels of the speaker housing together.

Similarly, smaller mounting towers 885 are provided to receive fasteners (e.g., screws) used to secure component housings or covers 830, 840 to the interior of the back panel 310. Thus, ribs 820C may also be formed extending along a portion of the interior surface 810 of the back panel 310 and up these smaller mounting towers 885 to again provide additional structural support to the speaker housing and especially the back panel 310. One such component housing or cover 830 may be provided to house and secure the power source for speaker 100, which in this embodiment is comprised of one or more rechargeable batteries (not visible under cover 830).

In embodiments like the one illustrated in FIG. 8, the batteries may be positioned below the midpoint of the speaker's height. This location of the batteries, which tend to be relatively heavy as compared to other speaker components, can advantageously provide a large amount or even a majority of the speaker's weight nearer the bottom of the speaker, which lowers the center of gravity of the speaker 100. This lowering of the center of gravity can help reduce the likelihood of the speaker tipping over. Moreover, in the illustrated embodiment, the large woofer 117 being employed typically includes a correspondingly large and heavy magnet at its rear. This magnet and the batteries typically comprise the large majority of the weight of the speaker. With the woofer 117 being substantially coextensive with the height of the interior surface of the front panel 110, its large magnet is substantially centered within the height of the speaker housing. As such, the magnet's weight is, generally speaking, equally distributed above and below the midpoint of the speaker's height, and thus the weight of the batteries being positioned substantially or entirely below this midpoint provides a significantly low total center of gravity for the speaker 100 since the large majority of the speaker's weight is positioned below its midpoint height. This combination results is an extremely high resistance to tipping over when resting on its bottom feet.

Another component cover 840 is also provided and used to house one or more components for operating the speaker 100. For example, under cover 840 may be secured one or more circuit boards or similar circuitry and associated wiring for use in controlling the speaker 100, illuminating the indicator lights 215 or other buttons, and driving the large driver and the tweeter to play sound from the speaker 100. The circuit board(s) may include contacts for the control buttons accessible from outside of the top panel 105 via wiring 867, as well as the lights, such as LEDs, providing the battery charge indicators displaying the charge state of the battery held within the interior of the speaker 100. Additionally, wiring 845A for driving the woofer 117 and wiring 845B for driving the tweeter 1010 can also be seen extending from the circuitry protected under cover 840. Of course, other control or similar circuitry may also be housed within the cover 840 or another, separate cover, as well as associated wiring extending therefrom.

As shown, any such cover 830, 840 included within the housing of the speaker 100 may be formed with vent holes or slots to permit cooling and ventilation for the components thereunder. A cooling fan and/or heat sinks for further dissipating heat from any such components may also be included. Importantly, in advantageous embodiments, the covers 830, 840 are formed as a single component that extends across a majority of the interior surface 810, as shown, to provide additional rigidity to the back panel 310. As such, in some embodiments, the covers 830, 840 may further include structural ribbing extending in one or more directions along the exterior surface of the covers 830, 840.

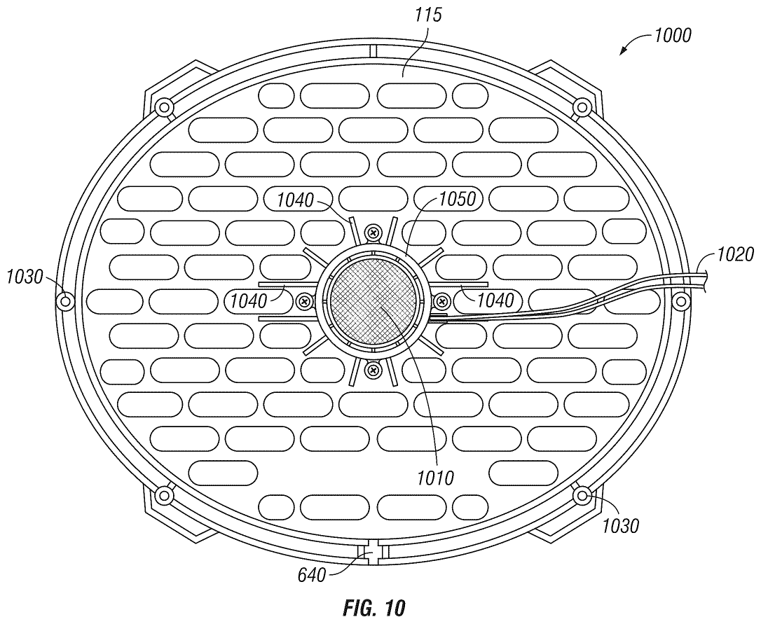

Included on the circuit board(s) may also be the active crossover circuitry for the speaker 100. Specifically, wireless speakers such as one constructed as disclosed herein typically include an onboard amplifier(s) because the wireless signals transmitted from the source device (e.g., a mobile phone) are not powerful enough to drive the woofer 117 and the tweeter 1010 (see FIG. 10) mounted in the grille 115. A passive crossover uses a combination of resistors, inductors and capacitors combined to form a filter network placed between a power amplifier and speaker drivers to divide the amplifier's signal into the necessary frequency bands before being delivered to the individual speaker drivers. However, since the amplifier circuitry is included on the circuit board(s) of the wireless speaker 100, an active crossover circuit may also beneficially be employed on the circuit board(s). An active crossover is a filter circuit that divides the signal into individual frequency bands before power amplification, thus requiring at least one power amplifier for each frequency band on the circuit board(s).

Also illustrated in FIG. 8 is a speaker driver support 850. This support 850 also extends perpendicularly from the interior surface 810 of the back panel 310 to a height selected to contact the rearmost portion of the woofer 117, which in this embodiment is the backside of the speaker magnet (not shown here, but discussed below). To maximize sound quality and volume level, a large woofer 117 is advantageously used within the speaker 100. However, as the size of the woofer 117 increases, so too does its weight, primarily at the rear of the driver where the magnet at the base of the voice coil is located. Excessive weight of the magnet causes stress on the mounting points of the woofer 117, which are located at its front along a flange surrounding and suspending the cone of the woofer 117. The flange is mounted to the inner surface of the front panel 105 with a seal between the flange and that interior surface to prevent water or other contaminants from reaching the interior of the speaker 100, and such stress can cause this seal to rupture. This stress on the mounting points along the flange of the woofer 117 is significantly increased when the speaker 100 is dropped or otherwise impacted. In these situations, the weight of the magnet will be caused to move horizontally with respect to the mounting flange of the woofer 117, or even pulling the woofer 117 perpendicularly away from mounting points. This increased stress can result in the woofer 117 being jarred loose from its mounting, thus moving around within the interior of the speaker 100. Naturally, such dismounting of the woofer 117 would greatly affect the operation and sound quality of the speaker 100.

To prevent such stresses, support 850 is provided to contact and support the base of the magnet of the woofer 117. By contacting and supporting the magnet of the woofer 117, by far its heaviest component, the magnet is prevented from moving horizontally or pulling away from the mounting point along the flange of the woofer 117. In some embodiments, the support 850 may include a fastening mechanism to attach it to magnet securely. In other embodiments, a magnet may be provided at the end of the support 850, and which is oriented to magnetically attract the magnet of the woofer 117 to secure its position. In some embodiments, a compressible material, such as rubber, may be provided at the end of support 850. In such embodiments, as the front and back panels are coupled together, the compressible material is compressed between the end of support 850 and the backside of the magnet of the woofer 117, and this compressive force is used to secure the magnet in place. Of course, other types of mechanisms for coupling or contacting the magnet of the woofer 117 may also be employed.

Also illustrated in FIG. 8 is a circuit board 860 for the charging port discussed above and used for recharging the batteries of the speaker 100. This circuit board 860 is protected from the elements when the cover 270 is closed and sealed. This circuit board 860, or another one located proximate to it, may also be included to provide electrical output from speaker's batteries. For example, a USB-A or similar port may also be provided under the cover 270 and employed by user to charge another device (e.g., a mobile phone) or provide power to another electronic device. Still further, another port may be included to provide audio output from the speaker 100 during use. For example, a 3.5 mm port may be included, along with its own circuitry, so that media being streamed to the speaker 100 may be output to another speaker or headphones. Similarly, such a 3.5 mm port, or other size port, may be included, along with its own circuitry, to provide media input to the speaker 100 rather than using a wireless input connection, such as Bluetooth. Still further, one or more XLR ports may also be included under the waterproof cover 270 to permit connection of the speaker to a public address (PA) system, amplifier, or other device employing the XLR protocol. Other ports and associated circuitry may also be included, and interconnected with batteries (via its circuitry) or the operating circuitry of the speaker 100, as needed. Wiring 865 is provided from such various circuitry and circuity boards to the operation circuitry protected under cover 840.

Also visible from the view of FIG. 8 are fastener receptacles 870 formed at the sides of the back panel 310. These receptacles 870 are sized to receive fasteners 140 introduced above. In some embodiments, the receptacles 870 each comprise a threaded sleeve sized for receiving corresponding fasteners 140 to assist coupling the front and rear panels together. In other embodiments, the fasteners 140 are self-tapping screws and the material in the area of the receptacles 870 is configured to receive the fasteners 140 to secure the two panels. Similarly, the towers 880 discussed above may also be positioned and sized to receive additional fasteners (not illustrated) to secure the front and rear panels together. Also, the top towers 887 may also be positioned and sized to receive mounting points at opposing ends of the handle 130, as illustrated. Around the entire perimeter of the back panel 310, a channel may be provided (not illustrated) for receiving a seal that works with a channel similarly formed along the perimeter of the front panel 105 to provide a waterproof seal between the two panels 105, 310 when they are coupled together. In some embodiments, a single channel may be provided on only one of the back or front panels, rather than on both.

Looking now at FIG. 8A, illustrated is an interior view 800A of an alternative embodiment of the interior of the back panel 310, also designed and constructed in accordance with the disclosed principles. As with all other embodiments, including the embodiment of FIG. 8, providing the structural integrity of the back panel 310 is a plurality of structural ribs 820 formed all throughout the interior surface 810 of the back panel 310. Like components of the interior of this embodiment of the back panel are numbered the same as equivalent components of the interior of the embodiment of the back panel illustrated in FIG. 8 and described above. Accordingly, all of the structural features and advantages disclosed herein for the embodiment illustrated in FIG. 8 also apply to the embodiment illustrated in FIG. 8A. Of course, other embodiments of the interior of a back panel of a speaker housing as disclosed herein may also include all of the structural features and advantages disclosed herein without departing from the breadth and scope of the disclosed principles.

Turning now to FIG. 9, illustrated is a front view 900 of the speaker 100 illustrated in FIGS. 1-8 with the grille removed. With the grille 115 removed, the front of the woofer 117 can be seen. Although in this embodiment of the speaker 100 as disclosed herein has a rectangular shape, and thus could receive an elliptical-shaped speaker driver (e.g., a 6×9 driver), a circular woofer 117 is advantageously used with the speaker 100. A circular speaker driver permits lower end waves (woofer-like) sounds as compared to an elliptical driver. Thus, an elliptical driver is tailored towards a mid-range driver and does not permit the same bass sounds as compared to a round driver. Indeed, this is why subwoofer speakers are made with circular drivers like the woofer 117 employed in the disclosed speaker 100.

As is typical with speaker drivers, the illustrated woofer 117 includes a suspension ring 910 suspending the speaker's diaphragm 920 (or “cone”) to permit movement of the diaphragm 920 during woofer 117 operation. In exemplary embodiments, the driver suspension 910 is comprised of a flexible and waterproof material, such as a high density foam, to permit the needed movement of the diaphragm 920 yet provide a waterproof seal for the interior of the speaker's housing. Other advantageous materials may also be used for the driver's suspension 910. Similarly, the diaphragm 920 is also advantageously formed of a waterproof material to assist in providing the waterproof seal to the interior of the speaker 100. For example, the diaphragm 920 may be constructed from a plastic material, a metal material, a carbon fiber material, or a composite material comprising one or more waterproof materials that can be employed as a speaker diaphragm 920.

Also visible in the view of FIG. 9 is the dust cap or “dome” 925 of the woofer 117. As with other components of the woofer 117, the dust cap 925 is also advantageously formed of a waterproof material to assist in providing the waterproof seal to the interior of the speaker 100. For example, the dust cap 925 may be constructed from a plastic material, a metal material, or a composite material comprising one or more waterproof materials. Also shown in this view 900 are mounting holes 930 each sized and configured to receive a fastener, such as screw, to secure the grille 115 to the front panel 105 of the speaker 100. While screws are advantageously used to secure the grille 115, in other embodiments, the fasteners may be pins, clips, or other manually removable fasteners, or the grille 115 may even be permanently mounted to the front panel 105 such as with an adhesive, chemical welding, heat welding, or other technique. Finally, wiring 940 is visible coming through the front panel 105 of the speaker 100 to electrically connect the tweeter (not shown) discussed above. A grommet, caulking, or other similar device or technique for providing a waterproof seal between the wires 940 and the hole 950 formed in the front panel 105 is used to ensure the waterproofing of the speaker housing.

Looking now at FIG. 10, illustrated is an interior view 1000 of the speaker grille 115 of the speaker 100 illustrated in FIGS. 1-9. From this view the rear of the tweeter 1010 discussed above can be seen, which is removably secured to the interior surface of the grille 115 in case replacement or repair of the grille 115 is ever needed. In other embodiments, the tweeter 1010 may be connected to and suspended in front of the front panel 105 of the housing using a skeleton or similar structure. In such embodiments, the grille 115 may thus be removed and replaced without having to unmount or disconnect the tweeter 1010. Such a skeleton structure, which can be constructed of a resilient material such as metal or plastic, may also provide additional structural support for the convex grille 115 to assist in resisting an impact that might cause the grille 115 to flex or bend inwardly and damage the woofer 117. The wiring 1020 to power the tweeter 1010 is also shown, where the distal ends of these wire 1020 are the wires 940 visible in FIG. 9. Fastener holes 1030 are formed at periodic locations around the perimeter of the grille 115, which in exemplary embodiments are each sized to receive a fastener, such as screw, received in the holes 930 on the front panel 105 of the speaker in order to secure the grille 115 to the front panel 105.

As with the interior of the back panel 310 discussed above, structural ribs 1040 are also provided on the interior surface of the grille 115. These ribs 1040 each extend along a portion of the interior of the grille 115, and rises up vertically from a cylindrical structure 1050 integrally formed with the interior of the grille 115 and sized to house the tweeter 1010 therein. These ribs 1040 are formed extending perpendicularly along portions of the interior of the grille 115 to provide structural support for the grille 115. Specifically, by extending along long portions of the interior surface of the grille 115 and the exterior surface of the tweeter structure 1050, these ribs 1040 remove some or all of the flexibility of the grille 115.

Turning finally to FIG. 11, illustrated is an interior view 1100 of the front panel 105 of the speaker 100 illustrated in FIGS. 1-10. Visible from this view 1100 is the backside of the magnet 1110 of the woofer 117 discussed in detail above. The large size of the magnet 1110 with respect to the length and width of the interior of the front panel 105 of the speaker 100 is notable in that the largest circular woofer 117 is advantageously selected to fill as much of the interior of the front panel 105 as possible in order to obtain the loudest and best sound quality from the selected size of the speaker housing. In this embodiment, the magnet 1110 is substantially coextensive in diameter with the outer diameter of the speaker cone discussed above.

Also provided at the center of the rear surface of the magnet 1110 is a stabilizing aperture 1110A. The stabilizing aperture 1110A is sized, in this embodiment, to receive the speaker driver support 850 discussed above in order to structurally stabilize (i.e., eliminate) movement of the large magnet 1110 should the speaker 100 be dropped or otherwise jarred. Stabilization of the magnet 1110 thus prevents movement of the rest of the speaker 100, which is secured to the interior face of the front panel 105 via the speaker flange 1115 with flange fasteners 1130 (e.g., screws, in this embodiment). The flange 1115 of a speaker 100 is typically relatively thin and thus could be bent or even torn by the leverage of the much heavier magnet 1110 if it is permitted to move sideways. Thus, employing the speaker driver support 850 to hold the magnet 1110 in place not only prevents the flange or other part(s) of the speaker 100 from being damaged if movement of the magnet 1110 was permitted, but also permits use of a thinner flange 1115 and other speaker structure extending from the flange 1115. This not only reduces speaker manufacturing costs and well as lessening overall weight of the speaker 100 despite selectively employing an oversized speaker magnet 1110.

Also visible on the interior surface of the front panel 105 are the fasteners 1140 (e.g., screws, in this embodiment) used to secure the grille 115 to the exterior surface of the front panel 105. The location of these mounting screws inside the speaker housing also prevents rusting of the screws by isolating them from exposure to external environmental elements. While use of a circular woofer 117 provides more low-end or bass acoustics as compared to an elliptical driver as discussed above, the circular shape also advantageously permits the grille fasteners 1140 to be accessible with the woofer 117 installed. Thus, if an elliptical driver (e.g., a 6×9 driver) was employed in the speaker 100, that driver would have to be removed before the grille fasteners 1140 were accessible. Such a design would add additional and unnecessary time and complexity to grille 115 replacement, should that be required. Although the grille 115 in illustrative embodiments of a speaker 100 as disclosed herein is constructed from break-resistant material (such as ABS plastic) and includes the structural ribs 1040 described above, the screen-like design of the grill 115 needed to permit acoustic waves to emanate from the woofer 117 results in the grille 115 being most likely the component of the speaker 100 to break should it be dropped. Thus, the ease of grille 115 replacement with the selection of the circular woofer 117 is an advantage to speakers 100 as disclosed herein. Wiring 1120 to the woofer 117 is also shown in FIG. 11, and those wires 1120 extend back to the operating circuitry for the speaker 100 discuss above.

Receptacles 1150 for the mounting towers 887 holding the handle 130 are also formed in the interior of the front panel 105. Receptacles 1060 are shown on opposing sides of the front panel 105 and are sized to receive the fasteners 140 introduced above with reference to FIG. 1. The fasteners 140 pass through the receptacles 1060 and then engage receptacles 870 formed in the back panel 310, see in FIG. 8, each of which may comprise a threaded sleeve sized for receiving the fasteners 140 to assist in coupling the front and rear panels 105, 310 together. Around the entire perimeter of the front panel 105 is another channel 1170 for receiving the seal that works with the channel 895 (discussed with reference to FIG. 8), similarly formed along the perimeter of the back panel 310, to provide a waterproof seal between the two panels 105, 310 when they are coupled together.

Right side tie down bar 410 and left side tie down bar 510 are also shown in the view 1100 of FIG. 11. A front end of each of these tie down bars 410, 510 is received in a respective tie down bar aperture 1180 formed in the front panel 105. Similarly, distal ends of these tie down bars 410, 510 are received in corresponding tie down bar apertures 890 (shown in FIG. 8) formed in the back panel 310. Thus, the tie down bars 410, 510 are secured in place by the closing of the front panel 105 and the back panel 310 when the housing of the speaker 100 is assembled.

Finally, structural ribs 1190 are formed all along the sidewalls of the front panel 105, and each extends along a portion of the interior surface of the front panel 105. These structural ribs 1190 provide significant reinforcement of front face and sidewalls of the front panel 105 by reducing or eliminated flexibility in the front face of the front panel 105 in the manner discussed above with respect to structural ribs 820, 820A, 820B, and 820C. While not provided in this illustrated embodiment, structural ribs 1190 may also be provided along the sidewalls of the interior structures for the receptables 1160 discussed above and the interior surface of the front panel 105. All of these structural ribs work collectively together to provide strength to the front face of the front panel 105 and back face of the back panel 310 to reduce or eliminate flex in the front and back faces, as well as the sidewalls of the front panel 105 and back panel 310. This strengthening protects the speaker 100 from cracking or breaking should the speaker 100 be dropped, but importantly the significant reduction or complete elimination of flexibility in the front and back faces significantly improves sound quality produced by the speaker 100. This is because during use of the speaker 100, acoustic waves are generated in the interior of the speaker 100, using the hollow cavity in the interior of the speaker 100 to reverberate the acoustic waves. In typical speaker construction, a vent is provided to permit the exiting of low frequency acoustic waves from the interior of the speaker housing. However, in a waterproof speaker in accordance with the disclosed principles, such a vent would obviously permit water and other contaminants to enter the interior of the speaker housing, thus affecting the speaker's 100 operation. Thus, in some embodiments, a speaker 100 as disclosed herein may include a bass diaphragm (not illustrated) that permits the exiting of low end waves reverberating in the interior of the speaker 100.

However, in some embodiments of a speaker in accordance with the disclosed principles, it may be undesirable to include a low end diaphragm as it would create a weak point in the sealed/waterproof housing of the speaker. The hollow cavity within the inner structure of the speaker 100 permits reverberation of the acoustic waves generated by the woofer 117. The role of the speaker enclosure and hollow cavity of a typical speaker is to prevent sound waves emanating from the back of a speaker driver, such as the woofer 117, from interfering destructively with the sound waves emanating from the front of the woofer 117. A sealed housing having a hollow cavity like that of a speaker 100 as disclosed herein prevents transmission of the sound emitted from the rear of the woofer 117 by confining the sound in a rigid and airtight box. However, a rigid enclosure/housing of the disclosed type reflects sound internally, which can then be transmitted back through the front-facing woofer 117. This type of sounds wave reflection results in degradation of sound quality because they interfere with the sound waves emanating from the front of the woofer 117. Because a sealed housing is desired for the advantages discussed above, handling the interference of these two sets of sounds wave in a manner that provides the best sound quality under these conditions becomes more important.

If a flexible speaker housing is used, Moreover, the pulses of the acoustic waves, particularly at higher amplitudes/volume, produced by a speaker can cause a thin-walled speaker housing to flex with each or certain pulses. By flexing in this manner, the shape of the speaker enclosure is constantly changing as the sound waves are produced by the speaker. This constant changing of enclosure shape results in unpredictable and chaotic interference between the forward generated sound waves and the rearward generated sound waves from the woofer 117. Such unpredictable sound wave interference more negatively affects sound quality as compared to such sound wave interference occurring within a rigid speaker enclosure. This is why loudspeakers are built with extremely rigid enclosures such as a wooden cabinet.

Since using wood for a speaker as disclosed herein which is built to resist water exposure, employing wood for the speaker housing is not an option. Not only would wood eventually succumb to water exposure, but the additional weight added to a large portable speaker of the type disclosed herein would hinder its portability. Plastic, because of its impregnable composition to water and other elements, is ideal for such an outdoor speaker, but the plastic must be relatively thin in order to reduce speaker weight. Disadvantageously, the thinner the plastic used for the speaker housing, the more housing flex occurs, especially in the front and rear faces where the panels are larger than on the sides, top or bottom of the speaker. As a result, the numerous ribs 820, 820A, 820B, 820C, and 1190 disclosed herein are strategically placed extending along the front and back faces of the front and back panels 105, 310, respectively, and extending perpendicularly along corresponding sidewalls of the front and back panels 105, 310 as well as structures (i.e., the “towers” disclosed herein) to provide the support to the speaker housing to significantly reduce or eliminate the flexibility of the front and back faces of the housing.

By eliminating the flexing of the front and back faces of the housing, sound wave interference between the forward and backward generated sound waves from the woofer 117 becomes constant. With a known constant sound wave interference like this, the processing circuitry and amplifier circuitry can be tuned to address this sound wave interference to achieve the best sound quality possible with the unavoidable sound wave interference that occurs with a sealed plastic housing. Indeed, in advantageous embodiments of a disclosed speaker, the circuitry is tuned such that the known, constant wave interference can actually add constructively to the output from the front of the cone, such as in conventional bass reflex designs employing a forward-facing bass vent. Such a design for a disclosed speaker can therefore be used to extend the effective low-frequency response and increase the low-frequency output of the front-facing woofer 117. Moreover, in some embodiments, the processing circuitry of a speaker in accordance with the disclosed principles may further include sound wave equalizer circuitry to permit on-the-fly user-based tuning of the sound quality based on the type of media being played through the speaker 100. In such embodiments, the equalizer circuitry may have multiple preset settings across the acoustic wave spectrum for a user to select, or may have individual tunable settings for each of a plurality of acoustic wave bandwidths.

### Sample Speaker Testing Results

The strength of portable speakers designed and constructed in accordance with the disclosed principles has been tested and proven through various tests. For example, sample speakers were subjected to longevity testing under high heat. Specifically, the speakers were run for 168 hours under a temperature of 35° C.±10° C. Functionality was tested every 24 hours, and full functionality was verified through the entire 168 hours.

In another test, sample speakers were subjected to extreme high temperature/high humidity one-half of a 12 hour cycle, and then extreme low temperature/low humidity for the second half of the 12 hour cycle, for 72 hours total. Specifically, the high temperature/high humidity was raised to 55° C. at 90% relative humidity, and then the temperature was decreased to −20° C. at 50% relative humidity for each 12 hour cycle. At the end of the 72 hours, after 6 cycles, full functionality was verified throughout and after the entire 72 hours.

In another extreme high/low temperature test, sample speakers were subject to an initial temperature of 20° C., then decreasing the temperature to 0° C. by 1° C./min. The samples were held at 0° C. for 4 hours, then the temperature was increased to 60° C. by 1° C./min. The samples were held at 60° C. for 4 hours, and then the temperature was decreased to 20° C. by 1° C./min where the samples were held at 20° C. for 2 hours. This temperature cycling was then repeated for 96 hours, and afterwards the samples had full functionality verified.

Another test of sample speakers was subjecting them to extreme humidity for long periods of time. Specifically, the speakers were held at 40° C.±3° C. at 95% humidity for 96 hours. Afterwards the sample speakers had full functionality verified.

Another test was an electrostatic discharge test to determine exemplary speakers'resistance to damage from electrostatic discharges from human touch or other sources having a built up static charge. Testing involved touching the samples at various locations, especially any metal or electroplated parts. After testing, all electrical components (e.g., ICs, transistors, etc.) all demonstrated full functionality.

In yet another test, sample speakers were dropped to determine the effect of impacts that are likely to occur during rough handling. Specifically, the samples were dropped from a height of 1.8 m onto a concrete floor 3 times, with each drop being once on a corner, once on a side panel, and once on the front or back panel of the sample. After the 3 drops, the samples were visually inspected for external physical damage, as well as inspected to determine if any internal components were damaged or jarred loose. In each test, the samples showed no signs of critical exterior damage beyond visible scuffs, nor any signs of internal component damage or loosening.

Samples speakers as disclosed herein were also subjected to vibration testing to test of the dynamic-mechanical robustness of such speakers during transportation or in typical use. Specifically, the samples were subjected to vibration equipment imparting random vibrations at 5-500 Hz 3G RMS for 1 hour per each X, Y, and Z axis or based on the ICE 60068-2-6-2007 requirement known in the art. During such testing, the loosening or losing of any internal or external component is considered a failure. However, afterwards the samples showed no signs of loosened or lost exterior or interior components.

Another test sample speakers were subject to was a rust test using salt spray. Specifically, the test involved spraying an NaCl solution (5%) at 35° C.+2° C. at 85% humidity, with a pH of the solution between 6.5 pH and 7.2 pH. After testing, the samples showed no signs of corrosion or other damage.

Similarly, sample speakers were tested for ultraviolet radiation resistance. Specifically, samples were subjected to 1120 W/m2 light for 96 hours. After testing, the samples showed no visible signs of fading, cosmetic defects, or other visible damage.

Another test sample speakers were subjected to was a waterproof test. Specifically, the sample speakers underwent an industry standard IPX7 test. Moreover, these tests were performed with the cover discuss herein enclosing the charging and other ports left open. After testing, the sample speakers had full functionality verified without any water entering their housings. Additionally, the samples did not show any visible signs of damage.

While this disclosure has been particularly shown and described with reference to preferred embodiments, it will be understood by those skilled in the pertinent field art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

What is claimed is:

1. A portable speaker, comprising:
a housing having a front panel, back panel, and side panels adjoining the front and back panels substantially parallel to each other;
a top panel adjoining upper ends of the front panel, back panel, and side panels;
a bottom panel adjoining lower ends of the front panel, back panel, and side panels;
a speaker driver affixed to an interior surface of the front panel and mounted at least partially within the housing through an aperture, wherein the speaker driver has a height substantially coextensive with a height of the front panel;
control circuitry having a wireless interface module receiving audio media from a wireless source, the control circuitry configured to drive the speaker driver to output the received audio media and to receive control inputs via a plurality of control buttons;
a power source providing power to components of the speaker; and
a plurality of structural ribs integrally formed with an interior surface of the back panel, at least some of the plurality of structural ribs extending along interior surfaces of one or more of the top panel, bottom panel, and side panels of the housing.

2. The portable speaker of claim 1, wherein some of the plurality of structural ribs formed with the interior surface of the back panel extend perpendicularly with others of the plurality of structural ribs formed with the interior surface of the back panel.

3. The portable speaker of claim 1, wherein the plurality of structural ribs comprises:
a group of top ribs extending from the back panel along an interior surface of the top panel;
a group of bottom ribs extending from the back panel along an interior surface of the bottom panel; and
a group of side ribs extending from the back panel along an interior surface of one or more of the side panels.

4. The portable speaker of claim 1, wherein the plurality of structural ribs comprises a group of tower ribs extending from the back panel up one or more towers extending perpendicularly from the interior surface of the back panel, each of said one or more towers configured to receive a corresponding fastener for securing the front panel and back panel together;

5. The portable speaker of claim 1, wherein the plurality of structural ribs comprises a group of corner ribs extending from the back panel up one or more of housing corners where:
the back panel adjoins the top panel;
the back panel adjoins the bottom panel; and
the back panel adjoins a side panel.

6. The portable speaker of claim 1, wherein the plurality of structural ribs comprises a thickness that is inversely proportional to a thickness of the back panel.

7. The portable speaker of claim 1, wherein the power source comprises rechargeable batteries and a majority of the power source is positioned below the midpoint of the height of the front and back panels.

8. The portable speaker of claim 1, further comprising channels formed inwardly on the side panels and sized to receive fasteners securing the front panel to the back panel such that the fasteners do not extend outside a perimeter of the side panels, said channels providing structural support for the housing by alternating inward and outward walls along the side panels.

9. The portable speaker of claim 1, wherein the wireless interface module comprises a Bluetooth module, wherein the Bluetooth module is configured to wirelessly connect a single wireless source and one or more additional Bluetooth modules of respective one or more additional wireless speakers.

10. The portable speaker of claim 1, further comprising a control panel in communication with the control circuitry, and having a plurality of buttons accessible from an exterior of the housing via one or more waterproof membranes covering the plurality of buttons.

11. The portable speaker of claim 1, further comprising a charging port in in communication with the power source via the control circuitry, the charging port accessible from an exterior the housing via a waterproof sealable cover mounted to the housing.

12. The portable speaker of claim 1, further comprising a support extending perpendicularly from an interior of the back panel and sized to engage and support a rear portion of the speaker driver.

13. The portable speaker of claim 1, further comprising a convex grille affixed to and extending from an exterior surface of the front panel, the grille having a plurality of horizontally aligned slots formed therethrough and a drain slot formed at a bottom of the grille.

14. The portable speaker of claim 1, further comprising support bands integrally across the top panel and the bottom panel in perpendicular directions thereby providing structural support to the housing.

15. A portable speaker, comprising:
a housing having a front panel, back panel, and sidewalls adjoining the front and back panels substantially parallel to each other;
a top panel adjoining upper ends of the front panel, back panel, and side panels;
a bottom panel adjoining lower ends of the front panel, back panel, and side panels;
a speaker driver affixed to an interior surface of the front panel and mounted at least partially within the housing through an aperture, wherein a height of the speaker driver is substantially coextensive with a height of the front panel, and a height and a width of the grille is substantially coextensive with a height and a width of the front panel, respectively;
a convex grille affixed to and extending from an exterior surface of the front panel, the grille having a plurality of horizontally aligned slots formed therethrough and a drain slot formed at a bottom of the grille;
control circuitry having a wireless interface module receiving audio media from a wireless source, the control circuitry configured to drive the speaker driver to output the received audio media and to receive control inputs via a plurality of control buttons;
a rechargeable power supply providing power to the control circuitry and components of the speaker;
a control panel in communication with the control circuitry, and having a plurality of buttons accessible from an exterior of the housing via one or more waterproof membranes covering the a plurality of buttons;
a charging port in in communication with the rechargeable batteries via the control circuitry, the charging port accessible from an exterior the housing via a sealable cover mounted to the housing; and
a plurality of structural ribs integrally formed with an interior surface of the back panel, at least some of the plurality of structural ribs extending along interior surfaces of one or more of the top panel, bottom panel, and side panels of the housing;
wherein some of the plurality of structural ribs formed with the interior surface of the back panel extend perpendicularly with others of the plurality of structural ribs formed with the interior surface of the back panel.

16. The portable speaker of claim 15, wherein the plurality of structural ribs comprises:
a group of top ribs extending from the back panel along an interior surface of the top panel;
a group of bottom ribs extending from the back panel along an interior surface of the bottom panel;
a group of side ribs extending from the back panel along an interior surface of one or more of the side panels;
a group of tower ribs extending from the back panel up one or more towers extending perpendicularly from the interior surface of the back panel, each of said one or more towers configured to receive a corresponding fastener for securing the front panel and back panel together; and
a group of corner ribs extending from the back panel up one or more of housing corners where:
the back panel adjoins the top panel;
the back panel adjoins the bottom panel; and
the back panel adjoins a side panel.

17. The portable speaker of claim 15, wherein the plurality of structural ribs comprises a thickness that is inversely proportional to a thickness of the back panel.

18. The portable speaker of claim 15, wherein a majority of the rechargeable power source is positioned below the midpoint of the height of the front and back panels.

19. The portable speaker of claim 15, wherein the wireless interface module comprises a Bluetooth module, where in the Bluetooth module is configured to wirelessly connect a single wireless source and one or more additional Bluetooth modules of respective one or more additional wireless speakers.

20. The portable speaker of claim 15, further comprising a support extending perpendicularly from an interior of the back panel and sized to engage and support a rear portion of the speaker driver.
